(19) United States
(12) Patent Application Publication
(10) Pub. No.: US 2018/0335139 A1
(43) Pub. Date: Nov. 22, 2018

(54) DETENT DEVICE FOR MANUAL TRANSMISSION

(71) Applicant: KYUNG CHANG INDUSTRIAL CO., Ltd., Daegu (KR)

(72) Inventors: Dong Won KIM, Daegu (KR); Jin Bo KIM, Daegu (KR)

(21) Appl. No.: 15/653,092

(22) Filed: Jul. 18, 2017

(30) Foreign Application Priority Data
May 18, 2017 (KR) 10-2017-0061543

(51) Int. Cl. F16H 63/38; G05G 5/02; F16H 61/24

(52) U.S. Cl. CPC F16H 63/38; F16H 63/20; F16H 61/24; G05G 5/02

(57) ABSTRACT

A detent device for a manual transmission may be provided. The detent device includes: a shift lever; a detent including a detent body and a bullet bar; an elastic member which is disposed in the bullet bar; a bullet which is disposed to be elastically supported at one end of the elastic member; and a groove portion including a plurality of catching grooves. The detent body has a spherical shape and is formed coaxially with the shift lever. One side of the bullet is elastically supported by the elastic member and the other side of the bullet is formed to contact with the groove portion. The bullet bar is formed on the detent body and is formed to protrude from the center of the detent body in a direction perpendicular to a longitudinal direction of the shift lever.

### CROSS-REFERENCE TO RELATED APPLICATIONS

This application claims priority from Korean Patent Application No. 10-2017-0061543, filed on May 18, 2017, which is hereby incorporated by reference in its entirety.

### BACKGROUND

### Field

The present disclosure relates to a detent device for a manual transmission, and more particularly to a detent device for a manual transmission, which is capable of overcoming a spatial limitation and of improving a shift operation feeling.

### Description of the Related Art

A transmission converts the power generated by an engine into a rotational force. In an internal combustion engine, a revolution per minute (RPM) band for obtaining the maximum torque is different from a revolution per minute (RPM) band for obtaining the maximum output. Therefore, it is necessary to select an appropriate shift position according to a vehicle speed or an engine RPM and to convert the power into a rotational force.

Here, a shift control apparatus controls a transmission. The shift control apparatus is divided into a manual shift control apparatus (a manual transmission) and an automatic shift control apparatus (an automatic transmission). The manual shift control apparatus changes manually the shift position based on a user's operation of the apparatus. The automatic shift control apparatus automatically changes the shift position.

In general, a shift lever assembly of the manual transmission transmits the operation power of the shift lever to the manual transmission, and thus, actuates a synchronizer of the manual transmission.

Hereafter, a prior art will be described with reference to FIG. 1.

The shift lever assembly of the manual transmission according to the prior art includes, as shown in FIG. 1, a shift lever 2 which is installed within a vehicle and allows a driver to perform the shift operation, a lever housing 4 into which a portion of the shift lever 2 is inserted, and a select cable and a shift cable 6 which are connected to a lower portion 3 of the shift lever 2 and transmits the operation power of the shift lever 2 to the manual transmission (not shown).

Here, the shift lever 2 is rotatably installed on a hinge 8 installed in the lever housing 4.

The operation of the prior art configured as above will be described as follows.

In the shift lever assembly of the manual transmission according to the prior art, when the shift lever 2 is operated in a selecting direction, the select cable transmits the operation power of the shift lever 2 to the manual transmission, and then a shift position desired by the driver is selected. Then, when the shift lever 2 is operated in a shifting direction “sh”, the operation power of the shift lever 2 is transmitted through the shift cable 6 to the manual transmission and the selected shift position is operated, so that the gear shift is performed.

However, the shift lever assembly of the manual transmission according to the prior art has a link structure which simply transmits the operation power of the shift lever to the transmission. Therefore, when the vehicle travels on uneven roads, etc., the shift lever is operated regardless of the driver's intention by the shaking of the vehicle, so that jump out occurs, in which gear engagement within the synchronizer is released. When the jump out occurs while driving, the engine speed suddenly rises, and thus, the engine is damaged or the power to the wheel of the vehicle is interrupted, so that safety accidents may occur.

### SUMMARY

One embodiment is a detent device for a manual transmission. The detent device includes: a shift lever; a detent including a detent body and a bullet bar; an elastic member which is disposed in the bullet bar; a bullet which is disposed to be elastically supported at one end of the elastic member; and a groove portion including a plurality of catching grooves. The detent body has a spherical shape and is formed coaxially with the shift lever. One side of the bullet is elastically supported by the elastic member and the other side of the bullet is formed to contact with the groove portion. The bullet bar is formed on the detent body and is formed to protrude from the center of the detent body in a direction perpendicular to a longitudinal direction of the shift lever.

The bullet bar and the groove portion are formed to protrude from the detent body 20 only in a single direction.

The elastic member is disposed within the bullet bar.

The elastic member is disposed outside the bullet bar.

The groove portion includes a first groove in which the bullet is located when the shift lever moves in a forward shift direction, a second groove in which the bullet is located when the shift lever moves in a backward shift direction, and a third groove which receives and contacts the other side of the bullet when the shift lever is located at a neutral position.

Raised spots over which the bullet passes are formed between the first groove and the third groove and between the second groove and the third groove, respectively.

The first groove includes a first point and second point. The first point is the deepest point in a bottom surface of the first groove, and the second point is the farthest point from the third groove. The first point is formed closer to the second point than the raised spot. The second groove includes a third point and a fourth point. The third point is the deepest point in a bottom surface of the second groove, and the fourth point is the farthest point from the third groove. The third point is formed closer to the fourth point than the raised spot.

The raised spots are formed in parallel.

The raised spots have a circular arc shape having the same radius with respect to the center of the third groove.

The third groove has a spherical shape.

The third groove and the other side of the bullet are formed to correspond to each other.

### BRIEF DESCRIPTION OF THE DRAWINGS

FIG. 1 is a view showing a shift lever assembly of a manual transmission according to prior art;

FIG. 2 is a perspective view showing a shift lever assembly of a manual transmission according to an embodiment of the present invention;

FIG. 3A is a perspective view showing a shift lever, a detent, and a groove portion in the shift lever assembly of FIG. 2 according to an embodiment of the present invention;

FIG. 3B is a cross sectional view showing the shift lever, detent, and groove portion in the shift lever assembly of FIG. 2 according to an embodiment of the present invention;

FIGS. 4(A) and 4(B) are views showing the groove portion according to the embodiment of the present invention;

FIGS. 5(A), 5(B), 5(C), and 5(D) are views showing an operating principle of a detent device of the manual transmission according to the embodiment of the present invention;

FIG. 6 is a cross sectional view showing another type of the shift lever, detent, and groove portion in the shift lever assembly of FIG. 2 according to an embodiment of the present invention; and

FIGS. 7(A) and 7(B) are views showing a groove portion according to another embodiment of the present invention.

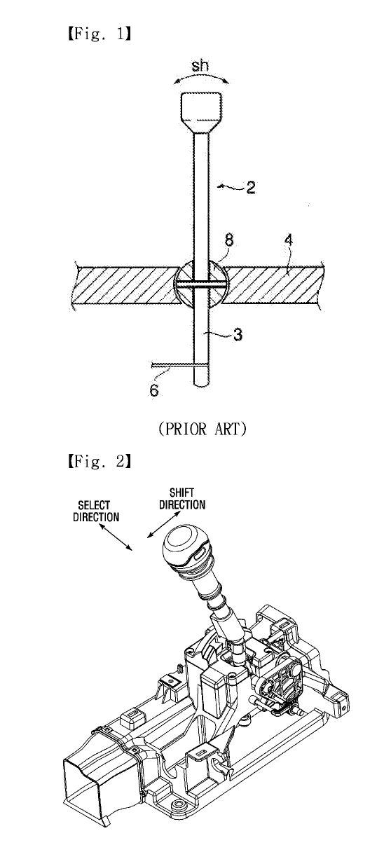

### DETAILED DESCRIPTION

Embodiments of the present invention will be described in more detail with reference to the accompanying drawings. In the components of the present invention, detailed descriptions of what can be clearly understood and easily carried into practice through a prior art by those skilled in the art will be omitted to avoid making the subject matter of the present invention unclear.

Hereafter, a detent device 300 of a manual transmission according to the embodiment of the present invention will be described.

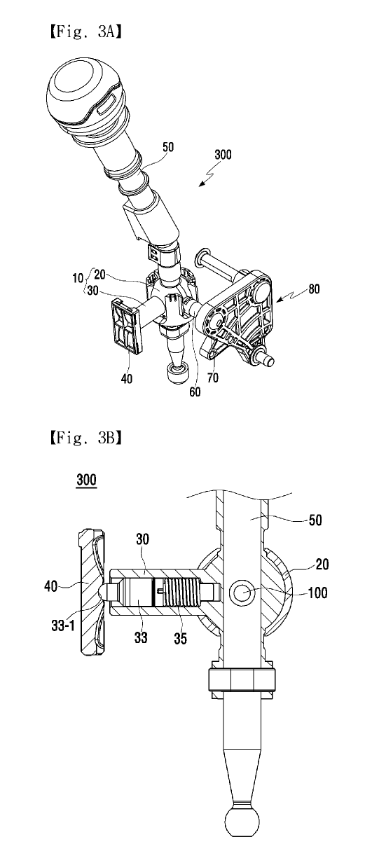

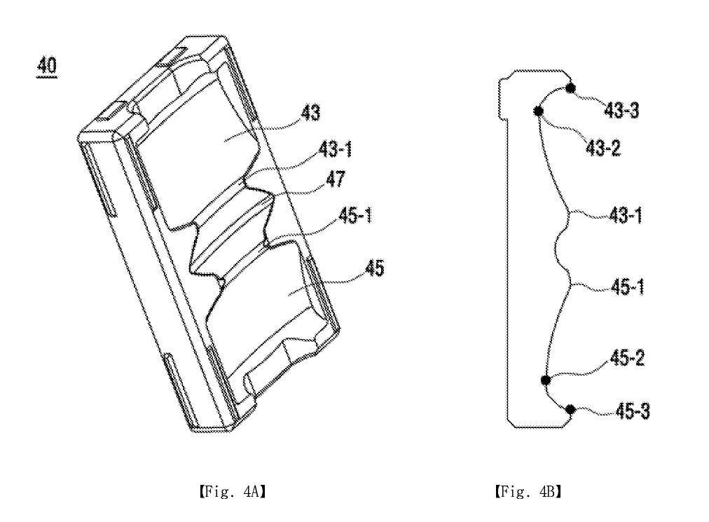

FIG. 2 is a perspective view showing a shift lever assembly of a manual transmission according to an embodiment of the present invention. FIG. 3A is a perspective view showing a shift lever, a detent, and a groove portion in the shift lever assembly of FIG. 2. FIG. 3B is a cross sectional view showing the shift lever, detent, and groove portion in the shift lever assembly of FIG. 2. FIG. 4 is a view showing the groove portion according to the embodiment of the present invention.

Referring to FIGS. 2 to 4, the detent device 300 of the manual transmission according to the embodiment of the present invention includes a shift lever 50, a detent 10, an elastic member 35, a bullet 33, and a groove portion 40.

The shift lever 50 allows a driver to select shift positions (the first shift position, the second shift position, and the third shift position, etc.). The shift lever 50 may move in a shift direction or in a select direction. The shift direction represents a moving direction of the shift position, and the select direction represents a direction perpendicular to the shift direction.

The detent 10 may be formed on the shift lever 50 and may include a detent body 20 and a bullet bar 30.

The detent body 20 may have a spherical shape and may be formed coaxially with the shift lever 50. The detent body 20 may be formed to have a spherical shape in order that the shift lever 50 moves smoothly when the shift lever 50 moves about a rotation center 100 in the shift direction or in the select direction. According to the embodiment of the present invention, the detent body 20 may have a polyhedral shape having multiple regular sides instead of the spherical shape if necessary so as to improve a gear shift distinction feeling.

The bullet bar 30 is formed on the detent body 20. The bullet bar 30 may be formed to protrude from the center of the detent body 20 in a direction perpendicular to the longitudinal direction of the shift lever 50. Specifically, the bullet bar 30 may be formed to protrude from the center of the detent body 20 in the shift direction. The bullet bar 30 may be integrally formed with the detent body 20. Also, in accordance with the embodiment, the bullet bar 30 may be formed as a separate component and assembled to the detent body 20.

The elastic member 35 and the bullet 33 may be disposed in the bullet bar 30. Specifically, the elastic member 35 and the bullet 33 may be disposed within the bullet bar 30.

The elastic member 35 may be disposed in the bullet bar 30. Specifically, the elastic member 35 may be disposed within the bullet bar 30. The elastic member 35 may elastically support the bullet 33. The elastic member 35 refers to a typical spring. The bullet 33 is able to move by the elastic force of the spring.

The bullet 33 may be disposed in the bullet bar 30. Specifically, the bullet 33 may be disposed within the bullet bar 30. The bullet 33 may be disposed to be elastically supported at one end of the elastic member 35. One side of the bullet 33 may be elastically supported by the elastic member 35, and the other side 33-1 of the bullet 33 may be formed and disposed to contact with the groove portion 40.

The other side 33-1 of the bullet 33 may move from a third groove 47 of the groove portion 40 to a first groove 43, and vice versa, or, from the third groove 47 to a second groove 45, and vice versa. The other side 33-1 of the bullet 33 may be formed to have a spherical shape for the purpose of smooth movements between the catching grooves 43, 45, and 47 of the groove portion 40. The spherical shape makes it possible to minimize the damage of the groove portion 40 or the bullet 33 due to friction.

Referring to FIG. 4, a perspective view of the groove portion according to the embodiment of the present invention is shown in FIG. 4(A), and a cross sectional view of the groove portion according to the embodiment of the present invention is shown in FIG. 4(B).

The groove portion 40 may include a plurality of the catching grooves 43, 45, and 47. Specifically, the groove portion 40 may include the first groove 43 in which the bullet 33 is located when the shift lever 50 moves in the forward shift direction, the second groove 45 in which the bullet 33 is located when the shift lever 50 moves in the backward shift direction, and the third groove 47 which receives and contacts the other side 33-1 of the bullet 33 when the shift lever 50 is located at a neutral position.

Also, the groove portion 40 may have raised spots 43-1 and 45-1 over which the bullet 33 passes. The raised spots 43-1 and 45-1 may be formed between the first groove 43 and the third groove 47 and between the second groove 45 and the third groove 47, respectively. The raised spots 43-1 and 45-1 may be formed in parallel.

The bullet 33 may contact the groove portion 40. Specifically, one side of the groove portion 40 may include the plurality of the catching grooves 43, 45, and 47, and the raised spots 43-1 and 45-1 formed between the plurality of the catching grooves 43, 45, and 47. The other side 33-1 of the bullet 33 may contact the one side of the groove portion 40 in which the plurality of the catching grooves 43, 45, and 47, and the raised spots 43-1 and 45-1 have been formed. The other side 33-1 of the bullet 33, which contacts the one side of the groove portion 40, may have a spherical shape for the purpose of smooth movement thereof.

The first groove 43 and the second groove 45 may have an inclined surface in the direction farther away from the third groove 47 and may have greater depths thereof the farther it gets from the third groove 47. Specifically, the first groove 43 includes a first point 43-2 and a second point 43-3. The first point 43-2 refers to the deepest point in the bottom surface of the first groove 43. The second point 43-3 refers to the farthest point from the third groove 47. The first point 43-2 may be formed closer to the second point 43-3 than the raised spot 43-1 instead of at the middle point between the second point 43-3 and the raised spot 43-1.

Likewise, the second groove 45 includes a third point 45-2 and a fourth point 45-3. The third point 45-2 refers to the deepest point in the bottom surface of the second groove 45. The fourth point 45-3 refers to the farthest point from the third groove 47. The third point 45-2 may be formed closer to the fourth point 45-3 than the raised spot 45-1 instead of at the middle point between the fourth point 45-3 and the raised spot 45-1.

The third groove 47 formed in the groove portion 40 and the other side 33-1 formed on the bullet 33 may be formed to correspond to each other. Specifically, the third groove 47 and the other side 33-1 of the bullet 33 may have the same curvature. This can reduce a clearance in the shift direction at the neutral position.

The detent device 300 according to the embodiment of the present invention, in which the elastic member 35 and the bullet 33 are disposed in the bullet bar 30, may have only one bullet bar 30 and only one groove portion 40. Specifically, the bullet bar 30 and the groove portion 40 may be formed to protrude from the detent body 20 only in a single direction. In this way, the detent device which has a simple structure and allows the driver to have the gear shift distinction feeling with minimum parts can be implemented.

The detent device 300 of the manual transmission according to the embodiment of the present invention may further include an extension part 60 and a side plate member 80.

The extension part 60 is formed on the detent body 20. The extension part 60 may be formed to protrude from the center of the detent body 20 in a direction perpendicular to the longitudinal direction of the shift lever 50. Specifically, the extension part 60 may be formed to protrude from the center of the detent body 20 in the select direction.

The end of the extension part 60 is received in a select direction moving part 70 of the side plate member 80, so that the side plate member 80 can accept the movement of the shift lever 50 in the select direction. A return spring (not shown) is provided to the side plate member 80. Therefore, when a force is not applied to the shift lever 50 in the select direction, the shift lever 50 can maintain the neutral position.

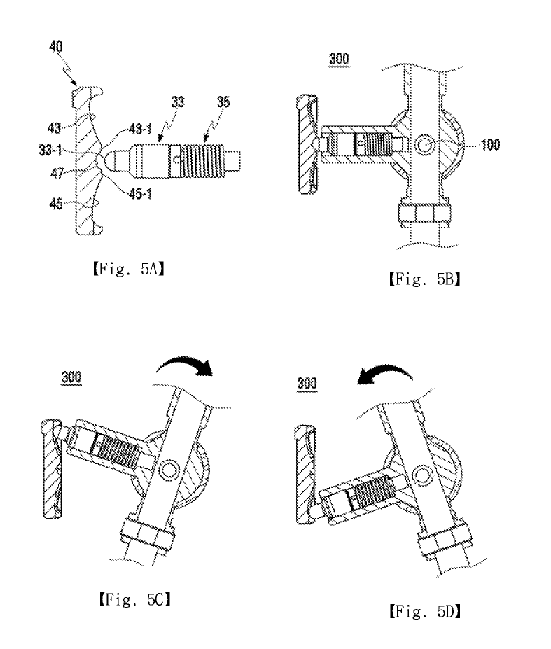

FIG. 5 is a view showing an operating principle of the detent device of the manual transmission according to the embodiment of the present invention.

Referring to FIG. 5, a view showing the groove portion, bullet, and elastic member of the detent device according to the embodiment of the present invention is shown in FIG.

5(A).

When the shift lever 50 is located at the neutral position or moves in the select direction, the other side 33-1 of the bullet 33 maintains the state of contacting the third groove 47 of the groove portion 40 (see FIG. 5(B)).

When the shift lever 50 moves in the forward shift direction, the shift lever 50 rotates clockwise about the rotation center 100 (see FIG. 5(C)). Here, the other side 33-1 of the bullet 33, which has been received in contact with the third groove 47 of the groove portion 40, moves to the first groove 43 of the groove portion 40 and contacts the first groove 43. In this case, the driver is able to have the gear shift distinction feeling while the other side 33-1 of the bullet 33 passes over the raised spot 43-1 formed between the first groove 43 and the third groove 47.

When the shift lever 50 moves in the backward shift direction, the shift lever 50 rotates counterclockwise about the rotation center 100 (see FIG. 5(D)). Here, the other side 33-1 of the bullet 33, which has been received in contact with the third groove 47 of the groove portion 40, moves to the second groove 45 of the groove portion 40 and contacts the second groove 45. In this case, the driver is able to have the gear shift distinction feeling while the other side 33-1 of the bullet 33 passes over the raised spot 45-1 formed between the second groove 45 and the third groove 47.

When the shift lever 50 moves from the front position to the rear position, the shift lever 50 rotates counterclockwise about the rotation center 100. Specifically, the other side 33-1 of the bullet 33 moves from the first groove 43 to the third groove 47 via the raised spot 43-1, and successively, moves from the third groove 47 to the second groove 45 via the raised spot 45-1. Here, the driver is able to have the gear shift distinction feeling while the other side 33-1 of the bullet 33 passes over the raised spots 43-1 and 45-1 respectively. The same is true for a case where the shift lever 50 moves from the rear position to the front position.

When the bullet 33 moves in the groove portion 40, the bullet 33 passes over the catching grooves 43, 45, and 47 formed in the groove portion 40 and the raised spots 43-1 and 45-1 formed in the groove portion 40, and the elastic member 35 may elastically support the bullet 33 by contracting and relaxing (restoring) by the depths of the catching grooves 43, 45, and 47 or the heights of the raised spots 43-1 and 45-1. The contraction and relaxation (restoration) of the elastic member 35 may allow the driver to have the gear shift distinction feeling.

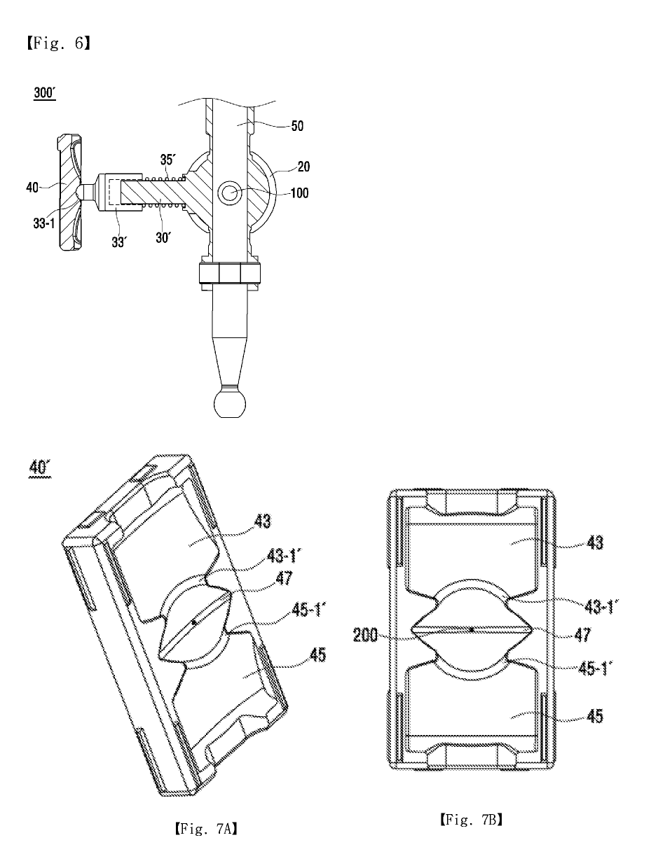

FIG. 6 is a cross sectional view showing another type of the shift lever, detent, and groove portion in the shift lever assembly of FIG. 2.

Referring to FIG. 6, although FIGS. 3b and 5 show that the bullet 33 and the elastic member 35 are disposed within the bullet bar 30, there is no limitation to this. According to the embodiment of the present invention, a bullet 33′ and an elastic member 35′ may be disposed outside a bullet bar 30′. The bullet 33′ may be disposed to be elastically supported at one end of the elastic member 35′. One side of the bullet 33′ may be elastically supported by the elastic member 35′, and the other side 33-1 of the bullet 33′ may be formed and disposed to contact with the groove portion 40. The one side of the bullet 33′, which is elastically supported by the elastic member 35′, has a groove formed there within. One end of the bullet bar 30′ may be inserted into the groove. The bullet 33′ may be elastically supported by the elastic member 35′ in such a way as to be moved by a predetermined interval in the longitudinal direction of the bullet bar 30′.

It doesn't matter whether the bullets 33 and 33′ and the elastic members 35 and 35′ are disposed inside or outside the bullet bars 30 and 30′ as long as the gear shift distinction feeling can be generated. It can be said that this is included in the embodiment of the present invention.

FIG. 7 is a view showing a groove portion according to another embodiment of the present invention.

A perspective view of a groove portion according to another embodiment of the present invention is shown in FIG. 7(A). A front view of the groove portion according to another embodiment of the present invention is shown in FIG. 7(B).

Raised spots 43-1′ and 45-1′ of a groove portion 40′ shown in FIG. 7 may have a circular arc shape having the same radius with respect to a center 200 of the third groove 47, while the raised spots 43-1 and 45-1 of the groove portion 40 shown in FIG. 4 are formed in parallel. When the raised spots 43-1′ and 45-1′ are formed in the form of a circular arc shape having the same radius with respect to the center of the third groove 47, the driver can have the same clearance feeling when operating the shift lever 50 in order to select his/her desired shift position.

The third groove 47 of the groove portion 40 may have a spherical shape. The third groove 47 may be formed to have an inwardly concave spherical shape in order that the other side 33-1 of the bullet 33 moves smoothly. For the purpose of minimizing the damage to the groove portion 40 or bullet 33 due to friction, the third groove 47 and the other side 33-1 of the bullet 33 may be formed to correspond to each other. In this way, the driver can have the same clearance feeling when operating the shift lever 50 in order to select his/her desired shift position.

In the detent device of the manual transmission according to the embodiments of the present invention, the detent device is disposed on the shift lever of the manual transmission, so that the driver can control the movement and have the gear shift distinction feeling (operation feeling).

Also, only one bullet and only one groove are disposed on the detent device, so that the detent device has a simple structure and allows the driver to have the gear shift distinction feeling and clearance feeling with minimum parts.

Also, the detent device which has a simple structure is implemented with minimum parts, so that the design space for the detent device can be minimized.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A detent device for a manual transmission, the detent device comprising:
a shift lever;
a detent comprising a detent body and a bullet bar;
an elastic member which is disposed in the bullet bar;
a bullet which is disposed to be elastically supported at one end of the elastic member; and
a groove portion comprising a plurality of catching grooves,
wherein the detent body has a spherical shape and is formed coaxially with the shift lever,
wherein one side of the bullet is elastically supported by the elastic member and the other side of the bullet is formed to contact with the groove portion,
and wherein the bullet bar is formed on the detent body and is formed to protrude from the center of the detent body in a direction perpendicular to a longitudinal direction of the shift lever.

2. The detent device for the manual transmission of claim 1, wherein the bullet bar and the groove portion are formed to protrude from the detent body only in a single direction.

3. The detent device for the manual transmission of claim 1, wherein the elastic member is disposed within the bullet bar.

4. The detent device for the manual transmission of claim 1, wherein the elastic member is disposed outside the bullet bar.

5. The detent device for the manual transmission of claim 1, wherein the groove portion comprises a first groove in which the bullet is located when the shift lever moves in a forward shift direction, a second groove in which the bullet is located when the shift lever moves in a backward shift direction, and a third groove which receives and contacts the other side of the bullet when the shift lever is located at a neutral position.

6. The detent device for the manual transmission of claim 2, wherein the groove portion comprises a first groove in which the bullet is located when the shift lever moves in a forward shift direction, a second groove in which the bullet is located when the shift lever moves in a backward shift direction, and a third groove which receives and contacts the other side of the bullet when the shift lever is located at a neutral position.

7. The detent device for the manual transmission of claim 3, wherein the groove portion comprises a first groove in which the bullet is located when the shift lever moves in a forward shift direction, a second groove in which the bullet is located when the shift lever moves in a backward shift direction, and a third groove which receives and contacts the other side of the bullet when the shift lever is located at a neutral position.

8. The detent device for the manual transmission of claim 4, wherein the groove portion comprises a first groove in which the bullet is located when the shift lever moves in a forward shift direction, a second groove in which the bullet is located when the shift lever moves in a backward shift direction, and a third groove which receives and contacts the other side of the bullet when the shift lever is located at a neutral position.

9. The detent device for the manual transmission of claim 5, wherein raised spots over which the bullet passes are formed between the first groove and the third groove and between the second groove and the third groove, respectively.

10. The detent device for the manual transmission of claim 6, wherein raised spots over which the bullet passes are formed between the first groove and the third groove and between the second groove and the third groove, respectively.

11. The detent device for the manual transmission of claim 7, wherein raised spots over which the bullet passes are formed between the first groove and the third groove and between the second groove and the third groove, respectively.

12. The detent device for the manual transmission of claim 8, wherein raised spots over which the bullet passes are formed between the first groove and the third groove and between the second groove and the third groove, respectively.

13. The detent device for the manual transmission of claim 9,
wherein the first groove comprises a first point and second point,
wherein the first point is the deepest point in a bottom surface of the first groove, and the second point is the farthest point from the third groove,
wherein the first point is formed closer to the second point than the raised spot,
wherein the second groove comprises a third point and a fourth point,
wherein the third point is the deepest point in a bottom surface of the second groove, and the fourth point is the farthest point from the third groove,
and wherein the third point is formed closer to the fourth point than the raised spot.

14. The detent device for the manual transmission of claim 10,
wherein the first groove comprises a first point and second point,
wherein the first point is the deepest point in a bottom surface of the first groove, and the second point is the farthest point from the third groove,
wherein the first point is formed closer to the second point than the raised spot,
wherein the second groove comprises a third point and a fourth point,
wherein the third point is the deepest point in a bottom surface of the second groove, and the fourth point is the farthest point from the third groove,
and wherein the third point is formed closer to the fourth point than the raised spot.

15. The detent device for the manual transmission of claim 11,
wherein the first groove comprises a first point and second point,
wherein the first point is the deepest point in a bottom surface of the first groove, and the second point is the farthest point from the third groove,
wherein the first point is formed closer to the second point than the raised spot,
wherein the second groove comprises a third point and a fourth point,
wherein the third point is the deepest point in a bottom surface of the second groove, and the fourth point is the farthest point from the third groove,
and wherein the third point is formed closer to the fourth point than the raised spot.

16. The detent device for the manual transmission of claim 12,
wherein the first groove comprises a first point and second point,
wherein the first point is the deepest point in a bottom surface of the first groove, and the second point is the farthest point from the third groove,
wherein the first point is formed closer to the second point than the raised spot,
wherein the second groove comprises a third point and a fourth point,
wherein the third point is the deepest point in a bottom surface of the second groove, and the fourth point is the farthest point from the third groove,
and wherein the third point is formed closer to the fourth point than the raised spot.

17. The detent device for the manual transmission of claim 9, wherein the raised spots are formed in parallel.

18. The detent device for the manual transmission of claim 9, wherein the raised spots have a circular arc shape having the same radius with respect to the center of the third groove.

19. The detent device for the manual transmission of claim 9, wherein the third groove has a spherical shape.

20. The detent device for the manual transmission of claim 9, wherein the third groove and the other side of the bullet are formed to correspond to each other.
